(19) United States
(12) Patent Application Publication
(10) Pub. No.: US 2026/0288625 A1
(43) Pub. Date: Sep. 24, 2026

(54) SYSTEMS AND METHODS FOR SECURELY TESTING COMPUTING CODE WITHOUT DOWNTIME OR OVER CONSUMPTION OF COMPUTING COMPONENTS

(71) Applicant: BANK OF AMERICA CORPORATION, Charlotte, NC (US)

(72) Inventor: Suryanarayan Parthasarathi Chakravarthi, Chennai (IN)

(73) Assignee: BANK OF AMERICA CORPORATION, Charlotte, NC (US)

(21) Appl. No.: 19/082,638

(22) Filed: Mar. 18, 2025

(51) Int. Cl. G06F 11/3668

(52) U.S. Cl. CPC G06F 11/3688

(57) ABSTRACT

Systems, computer program products, and methods are described herein for securely testing computing code without downtime or over consumption of computing components. The present disclosure is configured to identify computing code for testing; apply the computing code to a localized bucket, wherein the localized bucket is configured to securely apply at least one determined dataset to the computing code; determine, by a computing component allocator engine, at least one computing component to test the computing code; apply the at least computing component to the localized bucket; test, in the localized bucket, the computing code comprising the at least one determined dataset with the at least one computing component; determine, based on the testing of the computing code, a simulated outcome of computing code; and validate the computing code based on the simulated outcome.

### TECHNOLOGICAL FIELD

Example embodiments of the present disclosure relate to securely testing computing code without downtime or over consumption of computing components.

### BACKGROUND

In computing system environments, testing new versions of code, new code in general, and cyber security solutions has become increasingly important as these different solutions may cause unknowing cyber-attacks, data leakage, or code failures for their intended purpose which may further lead to downtime or production failures. Thus, a system configured to securely test computing code without downtime or over consumption of computing components in an efficient, secure, and automated manner is needed.

Applicant has identified a number of deficiencies and problems associated with securely testing computing code. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for securely testing computing code without downtime or over consumption of computing components.

In one aspect, a system for securely testing computing code without downtime or over consumption of computing components is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify computing code for testing; apply the computing code to a localized bucket, wherein the localized bucket is configured to securely apply at least one determined dataset to the computing code; determine, by a computing component allocator engine, at least one computing component to test the computing code; apply the at least computing component to the localized bucket; test, in the localized bucket, the computing code comprising the at least one determined dataset with the at least one computing component; determine, based on the testing of the computing code, a simulated outcome of computing code; and validate the computing code based on the simulated outcome.

In some embodiments, the validation of the computing code may further comprise: determine at least one production outcome associated with the at least one computing code or the at least one determined dataset, wherein the at least one production outcome is from a production environment outside of the localized bucket; compare the at least one production outcome to the simulated outcome; and determine, based on the comparison, an efficiency, a suitability, or an outcome of the computing code. In some embodiments, executing the computer-readable code is configured to cause the at least one processing device to: apply the efficiency, the suitability, or the outcome to the localized bucket via a feedback loop; update the localized bucket based on the application of the efficiency, the suitability, or the outcome; and determine, by the updated localized bucket, an updated at least one determined dataset, at least one updated computing code, or at least one updated computing component to improve at least one of the efficiency, the suitability, or the outcome of the computing code.

In some embodiments, the computing code is associated with at least one of a code update, a version upgrade, a new application, a new dataset, a security solution, or a streamed code.

In some embodiments, the at least one determined dataset is determined from a data model configured to select at least one pre-existing dataset from a plurality of pre-existing datasets or generate at least one synthetic datasets based on the at least one pre-existing dataset.

In some embodiments, the at least one determined dataset is a portion of a pre-existing production data or a portion of synthetic data based on pre-existing production data.

In some embodiments, the computing component allocator engine determines the at least one computing component based on the at least one computing component is idle.

In some embodiments, the computing component allocator engine comprises a grouping model that is configured to group and allocate available computing components based on at least one of historical production data or current production data.

In some embodiments, the computing code is saved on the at least one computing component for only a time required for testing.

In some embodiments, the localized bucket is isolated and secure from an operatively coupled network environment and a plurality of computing components in production within the operatively coupled network environment.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for securely testing computing code without downtime or over consumption of computing components, in accordance with an embodiment of the disclosure;

FIG. 2 illustrates a process flow for securely testing computing code without downtime or over consumption of computing components, in accordance with an embodiment of the disclosure;

FIG. 3 illustrates a process flow for determining an updates within the localized bucket for the computing code, such as updating the computing code, computing component, and/or the determined dataset, in accordance with an embodiment of the disclosure;

FIG. 4 illustrates a process flow for applying the computing component comprising the tested computing code to the production environment, in accordance with an embodiment of the disclosure; and

FIG. 5 illustrates a flow diagram for securely testing computing code without downtime or over consumption of computing components, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In computing system environments, testing new versions of code, new code in general, and cyber security solutions has become increasingly important as these different solutions may cause unknowing cyber-attacks, data leakage, or code failures for their intended purpose which may further lead to downtime or production failures. Thus, a system configured to securely test computing code without downtime or over consumption of computing components in an efficient, secure, and automated manner is needed.

Accordingly, the present disclosure provides an identification of computing code for testing; an application of the computing code to a localized bucket, wherein the localized bucket is configured to securely apply at least one determined dataset to the computing code; a determination, by a computing component allocator engine, of at least one computing component to test the computing code; and application of the at least computing component to the localized bucket; and a testing, in the localized bucket, of the computing code comprising the at least one determined dataset with the at least one computing component. Further, the disclosure provides for the determination, based on the testing of the computing code, of a simulated outcome of computing code; and a validation of the computing code based on the simulated outcome.

In other words, the disclosure provides a system for localized testing and acceptance of software code without downtime or unnecessary over-use of computing resources. For instance, the invention provides a system for evaluating a newly streamed code update and establishing a localized environment with existing production resources without any downtime in production for testing and implementation of approved code. The invention may use a localized bucket to model updated and newly streamed code using a currently-unused production resource, test outputs from the streamed code from the production resource using only a piece or small dataset of simulated input data, and determine the output of the streamed code in a secure and simulated environment before the secure code gets put in production.

What is more, the present disclosure provides a technical solution to a technical problem. As described herein, the technical problem includes the secure testing of computing code while avoiding downtime with computing components in production. The technical solution presented herein allows for the secure testing of computing code using idle computing components and light datasets comprising determined/pre-existing data and/or synthetic data. In particular, the present disclosure is an improvement over existing solutions to the secure testing of computing code, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

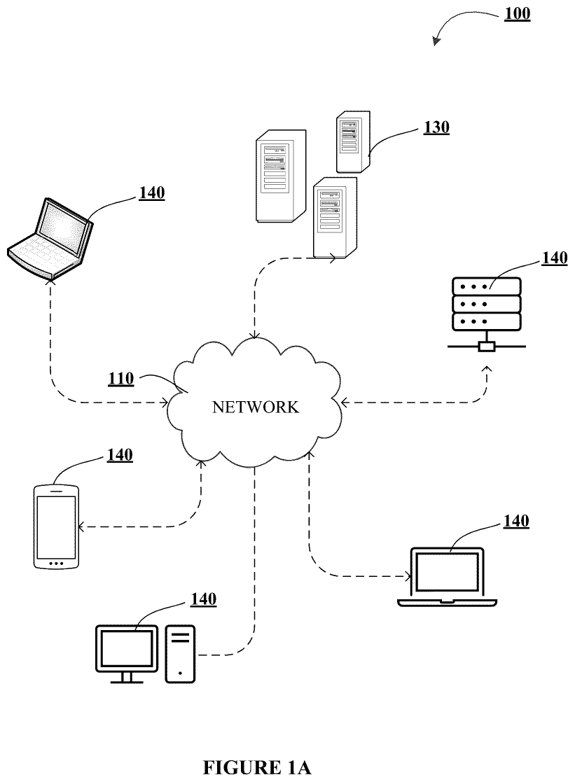

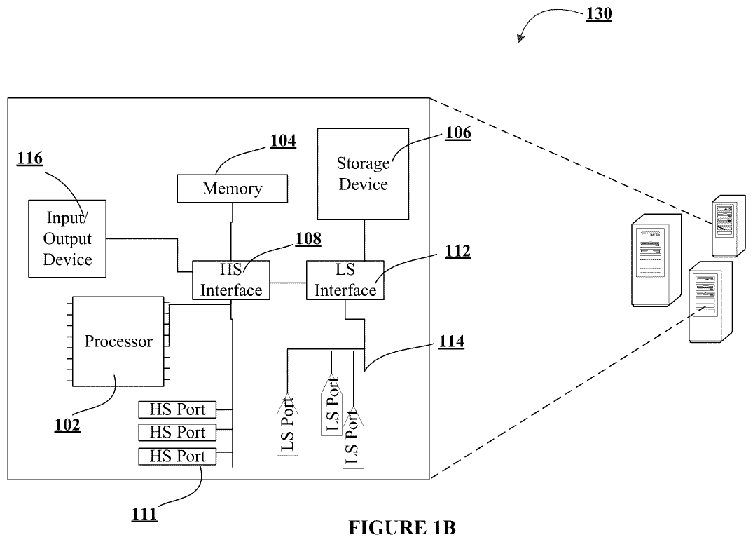

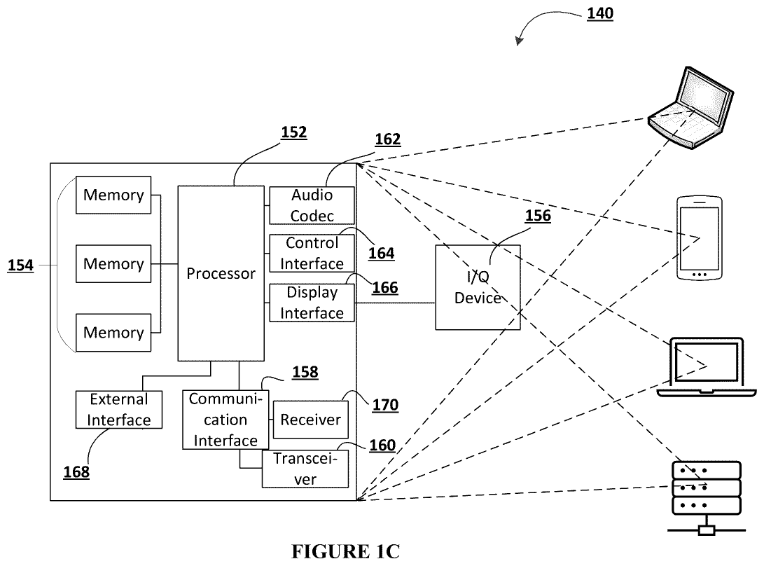

FIGS. 1A-1C illustrate technical components of an exemplary distributed computing environment for securely testing computing code without downtime or over consumption of computing components 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

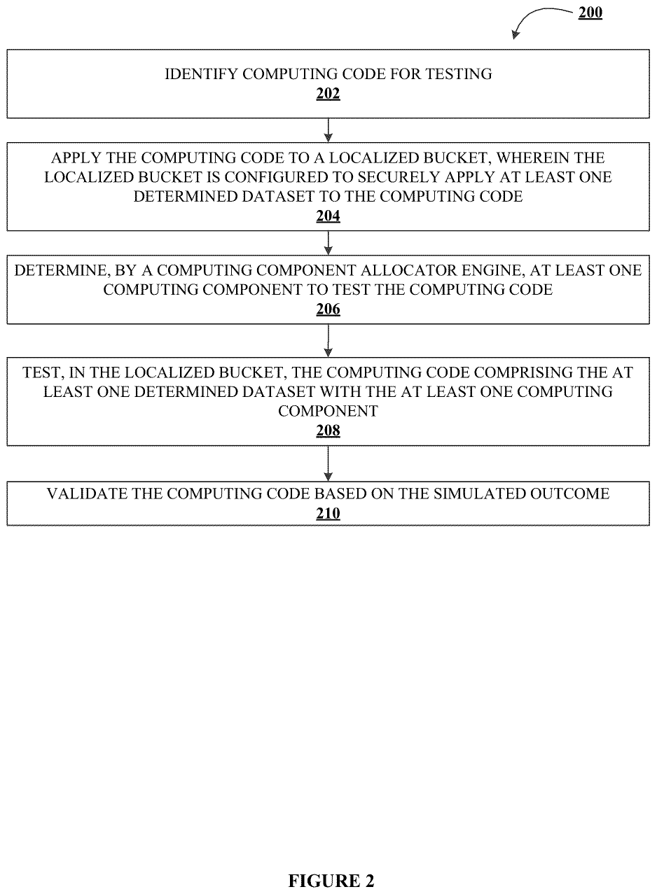

FIG. 2 illustrates a process flow 200 for securely testing computing code without downtime or over consumption of computing components, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying computing code for testing. For example, the computing code referred to herein may refer to computing code that is intended for production in a computing environment or network environment. Such computing code may comprise software, hardware, and/or the like. By way of non-limiting example the computing code may comprise software intended to affect one or more hardware components within a system environment or network environment, such as but not limited to a streamed code, a code update for code already found in the network environment or production environment (e.g., already live in the production environment), version upgrades of code already found in the network environment, cybersecurity code or solutions to the network environment, and/or the like. Thus, and in other words, the computing code may be associated with at least one of a code update, a version upgrade, a new application, a new dataset, a security solution, or a streamed code. In some embodiments, the computing code referred to herein may need to undergo testing before implementation in the production environment, and thus the system described herein may perform the testing required to validate the computing code before the computing code goes live in the production environment.

In some embodiments, the testing referred to herein for the computing code may comprise testing the computing code's efficiency at arriving at the intended outcome, the computing code's suitability for performing in the production environment, and/or the computing code's outcome as compared to the same or similar outcomes of the same or similar production environment computing code (i.e., currently live computing code). Thus, and based on the methods and processes described herein, the system may test the computing code in a secure and local environment isolated from the production environment before the computing code can be validated for production to the production environment. Such processes are described in further detail herein.

In some such embodiments, the computing code for testing may be identified by the system itself based on receiving the computing code from an external system (e.g., from a system associated with an external or third party vendor). In some embodiments, the system may identify the computing code for testing based on receiving an internal request from within the network associated with the system (e.g., from a user within the network that requests the computing code to be tested before production). In some embodiments, the system may identify the computing code to be tested based on identifying a new update and/or new version of current computing code within the production environment, whereby the new update and/or new version may have been attempted to be placed in the production environment automatically or via a download without prior testing, and/or whereby the new update and/or new version may be identified via web-crawlers as currently available.

As shown in block 204, the process flow 200 may include the step of applying the computing code to a localized bucket, wherein the localized bucket is configured to securely apply at least one determined dataset to the computing code. For example, the system may apply the identified computing code to a localized bucket for testing. Such a localized bucket may comprise a code model that is configured to process the computing code in production without impacting the existing production environment as the localized bucket may be separate and isolated during processing from the production environment. Thus, and in other words, the localized bucket refers to a virtual system that may store the computing code, execute the computing code using idle computing component(s) from the production environment, and determine outcomes of the computing code using the computing component(s) and/or determined datasets which may comprise real or synthetic input data for the computing code to process. In some such embodiments, the localized bucket may be configured to research, engineer, and/or tweak/change the computing code within localized bucket to refine and/or improve the computing code for production. Such a localized bucket, thus, may enable development and evaluation of the computing code, computing component(s), and/or the determined dataset(s) used to test the computing code.

Thus, and within the localized bucket, the computing code may be tested using the determined dataset(s) and at least one computing component determined by the system described herein. For example, the system may determine at least one determined dataset to test the computing code, where the determined dataset may comprise a subset of previous or historical data used for historical computing code in the production environment and/or synthetic data generated based on a subset of previous or historical data. In this manner, and in an instance where synthetic data is used, real data (such as sensitive information, personally identifying data, and/or the like) may remain secure and will not be exposed to the computing code being tested. In preferred embodiments, the determined dataset may comprise a small subset of data (i.e., light data) for testing the computing code in an efficient and computing component-saving manner, such that the computing component used to test the computing code can test the small subset/light data quicker than a full set or record of data. In other words, and in some embodiments, the at least one determined dataset may be a portion of a pre-existing production data or a portion of synthetic data based on pre-existing production data.

In some embodiments, the at least one determined dataset may be determined from a data model configured to select at least one pre-existing dataset from a plurality of pre-existing datasets or generate at least one synthetic dataset(s) based on the at least one pre-existing dataset. For example, the system may—using a data model—determine data to test the computing component by applying the determined dataset to the computing component as a test input. In this manner, and in some embodiments, the data model may be configured to determine the organization of real data used in the production environment and/or within an entity's database or system, and such organization may be used to determine the relationships between each piece of data, the likely outputs or outcomes related between each piece of data (e.g., similarities and/or differences between input data and output data), location of data within the database(s) and/or system, and/or the like. In some such embodiments, the data model may be configured to determine the optimal data to use as the determined dataset and/or to base the synthetic data used in the determined dataset for the testing of the computing code.

In some embodiments, the computing code may be saved on the at least one computing component for only a time required for testing. For example, and in order for the system to ensure zero downtime of the computing components within the production environment and used for testing the computing code, the system may ensure the computing code is saved on the determined computing code only long enough to test and validate or invalidate the computing code. Thus, and in other words, the computing component used to test the computing code will release the computing code in real time or near real time to the validation or invalidation of the computing code, and thus, the computing component will be available for its next task in the localized bucket or the production environment. Therefore, the computing components in the production environment will undergo now downtime or delay within the production environment and during the testing of the computing code as the computing components will be available for each of their assigned tasks. Further, and importantly, by testing the computing code with only light data (e.g., the determined dataset comprising a subset of data), the use of the computing component within the localized bucket with be streamlined and efficient for only short periods of time instead of the required long periods of time to test greater sizes of data.

As shown in block 206, the process flow 200 may include the step of determining, by a computing component allocator engine, at least one computing component to test the computing code. For example, the computing component allocator engine may be configured to identify a computing component to test the computing code with the determined dataset(s). As used herein, the computing component may comprise a central processing unit (CPU) and other such processors that may run and process the computing code. In some embodiments, a production environment may comprise multiple computing components (e.g., multiple CPUs), and the system described herein may be configured to identify one or more CPUs to test the computing code from the multiple computing components in use in the production environment. By way of non-limiting example, the production environment may comprise 100 CPUs, 97 of which CPUs may currently be in use with one or more tasks, and thus, 3 CPUs may be identified by the computing component allocator engine as idle and available for testing computing code. Thus, and using these idle CPUs, the computing component allocator engine may select one or more computing components (of the idle components) to test the computing code without disrupting the CPUs currently in use in the production environment.

In some embodiments, the computing component allocator engine may use a grouping model to determine an optimal computing component to test the computing code. For example, and in some embodiments, the grouping model may comprise a system or method for organizing data regarding computing components based on historical and current production data, historical and/or current computing code, and/or historical or current production data being processed. May group the computing components into logical groups based on shared functions (e.g., shared processes and/or functions with respect to computing code processed, outcomes or outputs generated, data processed, and/or the like). Thus, and based on this grouping model, the system may determine groups of computing components to test computing code, and based on this grouping, the system may determine which computing components within a group are idle and are available to test computing code without downtime of other computing components currently in production or delay of other computing components. Thus, and in other words, the computing component allocator engine may be configured to group and allocate available computing components based on at least one historical production data and/or current production data to determine which computing components from the production environment are currently idle (i.e., are in the production environment but are not currently being used).

In some embodiments, the grouping model may use attributes of computing components, such as but not limited to type, location, department, purpose, and/or the like to group computing components, and those computing components that share one or more attributes may be grouped together. In some embodiments, the grouping model may use behavior of computing components, and such behaviors may comprise actions or usage patterns based on historical data for each computing component to group the computing components. In some embodiments, the grouping model may group the computing components based on relationships shared between computing component, whereby the grouped computing components may share past or historical interactions (data transmissions, inputs and outputs, and/or the like) during historical production. In some embodiments, the computing component may be selected for testing the computing code based on historical use of the computing component for similar computing code, the same manufacturer of the computing code to be tested, the same or similar determined data to be tested with the computing code, and/or the like.

As shown in block 208, the process flow 200 may include the step of testing, in the localized bucket, the computing code comprising the at least one determined dataset with the at least one computing component. For example, the system may test—within the localized bucket—the computing code comprising the determined data as input and using the computing component determined above. As used herein, the localized bucket may be isolated and/or separate from the production environment, such that the localized bucket is secure from the production environment and the currently live computing code and live computing components. Thus, and in some such embodiments, the localized bucket may be isolated and secure from an operatively coupled network environment and a plurality of computing components in production within the operatively coupled network environment. In some such embodiments, the localized bucket may be operatively coupled and/or connected via a network or wired connection to the production environment, such that the localized bucket may receive the at least one computing component(s) to test the computing code during the computing component's idle time.

As shown in block 210, the process flow 200 may include the step of validating the computing code based on the simulated outcome. For instance, the system may determine the computing code is valid and thus, can be implemented in the production environment. In contrast, and in an instance where the system determines the computing code is invalid, the system may determine the computing code cannot be implemented in the production environment. In some embodiments, the invalidity of the computing code may be determined based on a production requirement not being met, such as but not limited to a requirement for an efficiency of the computing code, a suitability for the computing code, an outcome of the computing code, and/or the like. Therefore, and in some embodiments, the system may validate the computing code based on the system determining the suitability of the computing code is satisfactory, the efficiency is satisfactory (e.g., is fast enough) for the computing code, the outcome is satisfactory (e.g., the simulated outcome matches a production outcome), and/or the like.

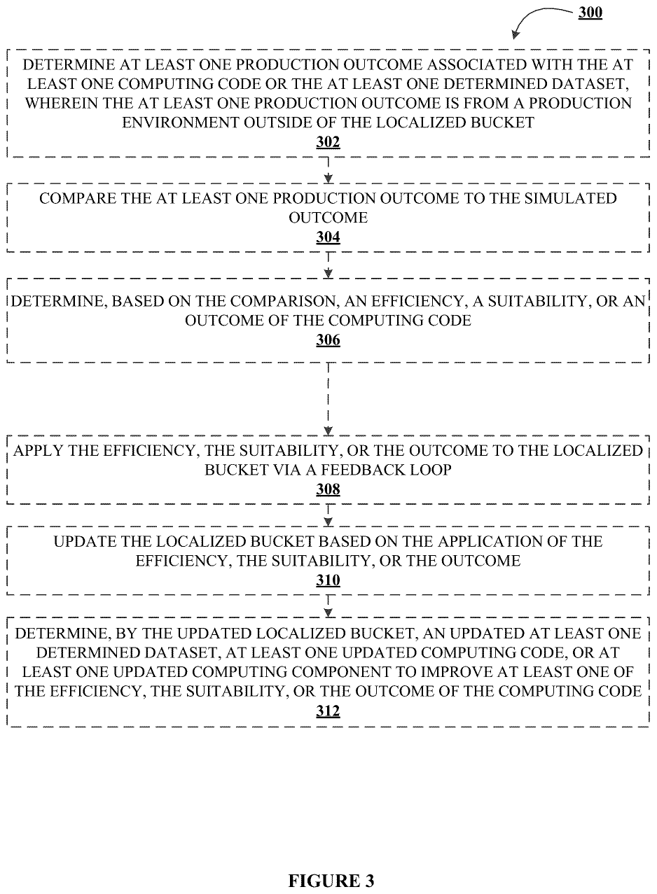

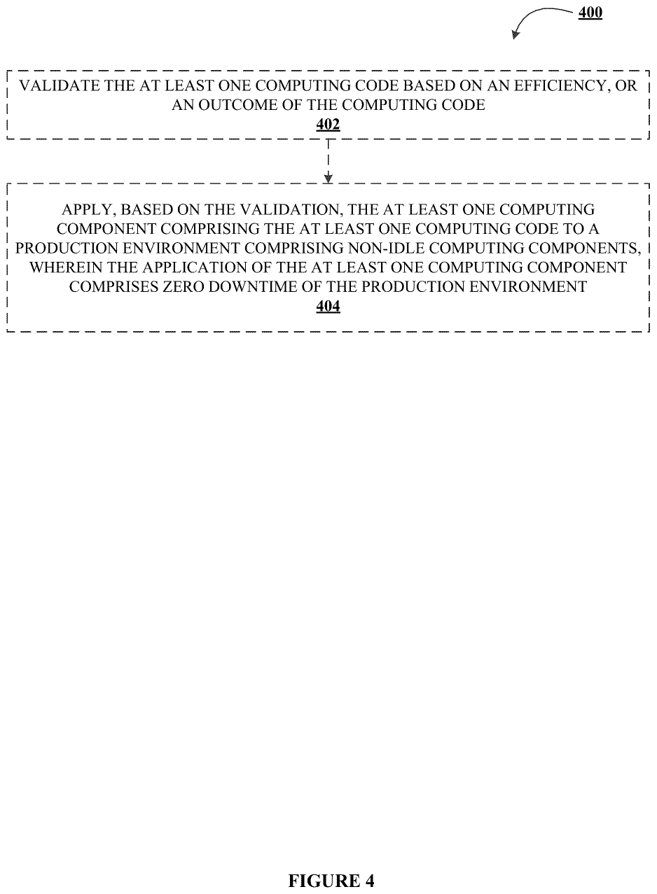

Further, and in some embodiments, the validation of the computing code may be based on a simulated outcome. Such a simulated outcome may be the outcome of the computing code after the computing component comprising the computing code processes the determined dataset(s) as an input. Thus, the simulated outcome may be rendered as an output of the computing code within the computing code, and the simulated outcome may be compared to a production outcome (real-world outcome within the production environment) to test whether the computing code will work for its intended purpose as compared to computing code that is currently or historically in production. Such validation of the computing code is described in further detail below with respect to FIGS. 3 and 4.

FIG. 3 illustrates a process flow 300 for determining an updates within the localized bucket for the computing code, such as updating the computing code, computing component, and/or the determined dataset, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of determining at least one production outcome associated with the at least one computing code or the at least one determined dataset, wherein the at least one production outcome is from a production environment outside of the localized bucket. For example, the system may determine the production outcome based on historical production outcomes of the same determined dataset or a similar determined dataset the synthetic dataset input is based on that is applied to the computing code tested or a similar computing code in the production environment. Thus, and in this manner, the system may determine the closest production outcome to compare with the simulated outcome based on at least one of a similar input (e.g., the dataset in the production environment is the same or similar), a similar computing code (e.g., the computing code in the production environment has the same purpose, same manufacturer/creator, same process, and/or the like), and/or the same computing component. For example, and in some embodiments, a different version of the same computing code being tested may have been used to generate the production outcome. Similarly, and in some embodiments, a similar computing code (e.g., based on similar outcomes, purposes, manufacturers, and/or the like) may be used to identify the production outcome to compare with the simulated outcome.

Thus, and as used herein, “production outcome” refers to a real outcome within the production environment separate from the localized bucket. Such a production environment also refers to the live environment where computing code can be used and accessed using live computing components. Thus, it is extremely important the computing code within the production environment has been tested, debugged, and secure before going live in the production environment.

In some embodiments, and as shown in block 304, the process flow may include the step of comparing the at least one production outcome to the simulated outcome. For example, and as used herein, the terms “compare,” “comparison,” and/or “comparing” refers to the determination of similarities and differences between two or more events, values, outputs, and/or the like. Thus, and as used herein, the system may compare the simulated outcome generated in FIG. 2 to the production outcome referred to herein. In some such embodiments, the production outcome may comprise the same length of data (e.g., same length of data points as the simulated outcome), such that the same number of data points between the simulated outcome and the production outcome are compared on a one-to-one basis. In some embodiments, and by way of non-limiting example, if the determined dataset comprises 30% of a record of a real data used in a production environment (e.g., 100 records and 30 of those records are used as a basis to generate synthetic data for the determined dataset to test computing code), and the production outcome of the 100 records shows 30 of those records used as a basis comprises 50% of type A data (e.g., where type A may be associated with a transaction type) and 50% of Type B (e.g., Type B transaction type, which may be different from Type A) within the production outcome. Thus, and when comparing the simulated outcome generated from the determined dataset comprising the 30 records (or synthetic 30 records based on the real records), then the system may determine the computing code works as intended in an instance where the simulated outcome comprises the expected 50% of type A and 50% of type B data. Thus, and in this manner, the entire 100 records will not need to be input to the computing code for testing, instead only light data or a portion of data (e.g., 30 records or 30 synthetic records) are input to the computing code for efficient and secure testing.

In some embodiments, and as shown in block 306, the process flow 300 may include the step of determining, based on the comparison, an efficiency, a suitability, or an outcome of the computing code. For instance, and as used herein, the efficiency of the computing code refers to how well the computing code uses the computing component(s) and its associated resources (e.g., processing power, memory, and/or the like) to perform and generate the simulated outcome in as short a time as possible without waste. Thus, and based on the efficiency of the computing code, the system may determine how well and how quickly the computing code performs without wasting computing resources. In some embodiments, the system may determine the efficiency of the computing code based on a timestamp collected from the start of the computing component's processing of the computing code and the determined dataset to a timestamp collected at the generation of the simulated outcome, and based on the space (e.g., memory) taken during the computing component's processing of the computing code and the determined dataset. In some embodiments, the system may determine the efficiency of the computing code in the production environment that the production outcome was generated from in order to determine if the efficiency of the computing code being tested meets and/or exceeds the efficiency of the production environment computing code. In some embodiments, and where the efficiency of the computing code being tested meets or exceeds (e.g., is faster and/or does not take up as much memory or uses the same or less computing resources) the production environment computing code, the system may determine the efficiency of the tested computing code is satisfactory.

Additionally, and in some embodiments, the system may determine a suitability of the computing code during testing. In some such embodiments, the suitability may refer to the computing code's ability to meet the intended purpose of the computing code and any requirements of users of the production environment, requirements within the production environment (e.g., language requirements, space requirements, operating system requirements, and/or the like), and/or the like. In some embodiments, the system may determine user requirements based on historical instances in the production environment comprising user feedback indicating likes and dislikes by users accessing and/or using similar computing code or computing code for similar purposes. Thus, and based on these historical likes and dislikes, the system may determine user requirements to compare with the computing code being tested and to determine if the computing code meets the suitability requirements. In some embodiments, the suitability of the computing code may comprise a score, which may be indicated as a percentage, a whole value, and/or the like, and may indicate a greater suitability based on a higher score. In some embodiments, the system may determine the suitability of the computing code in the production environment that the production outcome was generated from in order to determine if the suitability of the computing code being tested meets and/or exceeds the suitability of the production environment computing code. In some embodiments, and where the suitability of the computing code being tested meets or exceeds (e.g., meets the same or more of the suitability requirements as compared to the suitability of the production environment computing code) the suitability environment computing code, the system may determine the suitability of the tested computing code is satisfactory.

Additionally, and in some embodiments, the system may determine an outcome of the computing code that was tested. Thus, and in some such embodiments, the outcome of the computing code being tested may determined based on the comparison of the simulated outcome to the production outcome. Similar to the example provided above, and where the simulated outcome comprises 50% of Type A and 50% of Type B data, the system may determine the simulated outcome meets the outcome requirement. In contrast, and where the simulated outcome fails to comprise 50% of Type A and 50% of Type B, then the system may determine the simulated outcome does not meet the outcome requirement and the system may feedback the computing code, the computing component, and/or the determined dataset to the localized bucket for further testing and refining. In some embodiments, the system may determine the outcome of the computing code in the production environment that the production outcome was generated from in order to determine if the outcome of the computing code being tested matches the outcome of the production environment computing code. In some embodiments, and where the outcome of the computing code being tested matches (e.g., 50% of Type A and 50% of Type B data) the production environment computing code, the system may determine the outcome of the tested computing code is satisfactory.

In some embodiments, the system may require each of the efficiency, the suitability, and the outcome to be satisfactory for the tested computing code to be placed in the production environment. However, and in some embodiments, the system may require only one of the efficiency, suitability, or outcome to be satisfactory for the tested computing code to be placed in the production environment. In some embodiments, the requirements for the tested computing code to be placed in the production environment may be pre-determined via a user input in the system, such as but not limited to a user input form a manager of the system, from a manager of the production environment, and operator of the computing components in the production environment, and/or the like.

In some embodiments, and as shown in block 308, the process flow 300 may include the step of applying the efficiency, the suitability, or the outcome to the localized bucket via a feedback loop. For example, and in some embodiments, the system may apply the efficiency, suitability, and/or the outcome to the localized bucket as a feedback loop to the localized bucket for further refining of the computing code tested, the computing component(s) used to test, and/or the determined data used for testing. In this manner, the system may update at least one of the computing code being tested, the determined dataset used for testing, and/or the computing component used for testing, to determine a new simulated outcome and determine, based on this simulated outcome, the efficiency, suitability, and/or outcome.

In some embodiments, and as shown in block 310, the process flow 300 may include the step of updating the localized bucket based on the application of the efficiency, the suitability, or the outcome. For example, the system may update the localized bucket for further testing to determine the optimized computing code for production. Such updating may comprise updating the computing code being tested (e.g., updating one or more lines of code, and/or the like), updating the computing components testing the computing code, and/or updating the determined dataset(s) applied to the computing code for testing. Therefore, and in some such embodiments, the system may be configured to automatically and dynamically update the computing code being tested by updating at least one or of the computing code itself (e.g., the lines of code, the computing resources accessed via the lines of code, and/or the like), the determined dataset used for input, and/or the computing component(s) used for processing the computing code, in order to determine if the tested computing code can be satisfactory for the efficiency, suitability, and/or outcome and can be placed in the production environment.

In some embodiments, and as shown in block 312, the process flow 300 may include the step of determining, by the updated localized bucket, an updated at least one determined dataset, at least one updated computing code, or at least one updated computing component to improve at least one of the efficiency, the suitability, or the outcome of the computing code. For example, the system may determine an updated determined dataset, updated computing code, and/or updated computing component to test the computing code in a secondary, or later instance. Thus, and based on updating at least one of the computing code, the determined dataset, and/or the computing component, the localized bucket testing the computing code may be referred to as the updated localized bucket. Therefore, the updated localized bucket may run the processes described herein to update the simulated outcome and determine if the computing code is satisfactory based on the updated efficiency, updated suitability, and/or updated outcome for placement in the production environment.

In some embodiments, the processes described herein for updating the computing code, the determined dataset, and/or the computing component(s) may repeated for the computing code until computing code is placed in the production environment after testing. However, and in some embodiments, the processes described herein may be limited to an iterative limit (e.g., a limit of 3 iterative processes for updating the computing code, determined datasets, computing components, and/or the like) and the computing code may be determined as not satisfactory for the production environment if after the iterative limit, the efficiency, suitability, and/or outcome are still not satisfactory. Thus, and in this manner, computing resources and time may be conserved for testing other computing code and/or for live running of computing code in the production environment. In some embodiments, such an iterative limit may be pre-determined by the system itself, by a user of the system, by a user of the production environment, by a manager of the production environment or system, and/or the like.

FIG. 4 illustrates a process flow 400 for applying the computing component comprising the tested computing code to the production environment, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of validating the at least one computing code based on an efficiency, or an outcome of the computing code. For example, the system may validate the at least one computing code, whereby the validation of the computing code refers to the determination that the computing code tested is satisfactory to be placed in production in the production environment, and thus is satisfactory to be live in the production environment (e.g., based on the suitability, outcome, and/or efficiency). Such suitability, efficiency, and/or outcome may be determined as satisfactory using one or more of the processes described above with respect to FIG. 3.

In some embodiments, and as shown in block 404, the process flow 400 may include the step of applying, based on the validation, the at least one computing component comprising the at least one computing code to a production environment comprising non-idle computing components, wherein the application of the at least one computing component comprises zero downtime of the production environment. For example, the system may apply the computing code used for testing to the production environment in real time or near real time after the validation of the computing code. In some embodiments, and where the localized bucket is updated with the updated computing code, updated determined dataset, and/or updated computing component(s), then the system may—after validating the computing code in the updated localized bucket—apply the computing code from the updated localized bucket to the production environment using the computing component(s) from the updated localized bucket.

Thus, the idle computing component used for the validated computing code may be triggered to be non-idle or live within the production environment with the validated computing code. Therefore, the application of the computing component with the computing code to the production environment may be done in such a way that there will be no downtime and now waste of computing components or resources. By way of non-limiting example, the production environment may comprise 100 CPUs, 10 of which may be currently idle (e.g., have no current tasks within the production environment and thus, available for testing computing code), the system may use 1 CPU of the 10 idle CPUs to test computing code and validate the computing code. Thus, and where the computing code is validated with the 1 idle CPU, the system may automatically and in real time or near real time apply the 1 CPU with the validated computing code back to the production environment such that there is zero downtime for the production environment and the computing code can be applied within the production environment seamlessly and efficiently.

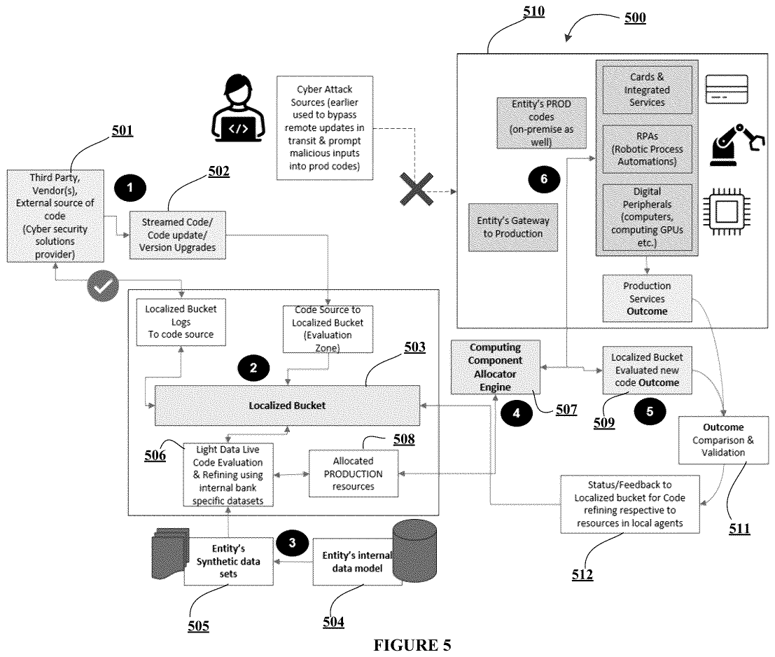

FIG. 5 illustrates a flow diagram 500 for securely testing computing code without downtime or over consumption of computing components, in accordance with an embodiment of the disclosure. In some embodiments, a system (e.g., similar to one or more of the systems described herein with respect to FIGS. 1A-1C) may perform one or more of the steps of flow diagram 500. For example, a system (e.g., the system 130 described herein with respect to FIG. 1A-1C) may perform the steps of flow diagram 500.

For example, and as shown in flow diagram 500, the process of securely testing computing code without downtime or over consumption of computing components with identifying computing code to be tested from a third party, vendor(s), external source of code (cyber security solutions provider), and/or the like 501. Such computing code may be in the form of streamed code, a code update or version upgrade 502. Additionally, and upon identifying the computing code, the system may apply the computing code to the localized bucket 503 for testing.

In some embodiments, the localized bucket 503 may be configured to receive determined data in the form of historical data used from an entity's internal data model 504 (i.e., a data model) and/or from an entity's synthetic datasets 505 which may be based on or modeled after an entity's historical data. Such a localized bucket 503 may be a code model that can process updated/new computing code in production without impact to existing production systems (e.g., like production environment 510) in its entirety and the localized bucket 503 may also research, engineer, and tweak codes within the localized bucket. Further, and as shown in flow diagram, the determined data applied to the computing code for testing may be referred to as light data and thus, the determined dataset may only comprise a portion of real or synthetic datasets for quick and efficient testing, rather than using full datasets for testing. For example, the system may be configured to generate light data from an entity's internal datasets, like the light data live code evaluation and refining internal entity specific datasets 506. In other words, the localized bucket 503 may employ entity and/or industry specific internal data models to arrive at accurate results instead of sample test results.

Additionally, the localized bucket 503 may be configured to receive production computing resources 508, from the computing component allocator engine 507, for testing the computing code from one or more idle computing components from the production environment. Such a computing component allocator engine 507 may be an intelligent resource grouping model that is configured to decide, group, and allocate available production resources in a manner not stalling production or causing any negative impacts to services (e.g., both digital and non-digital services based on internal resource details facilitating data/product movement). The computing component allocator engine 507 may enable a mechanism where the computing code for testing are not saved on the allocated computing components, and hence the computing code can be released from the computing component(s) for the next task in production without downtime or delay in the production environment.

Further, and as shown in flow diagram 500, the localized bucket 503 may generate the simulated outcome from tested computing code with the allocated computing component(s) and the determined dataset. Such simulated outcome is shown as localized bucket evaluated new code outcome 509 within flow diagram 500. Further, and upon generating the simulated outcome, the system may compare the simulated outcome to the production outcome 511, which may have been received from production environment 510. Such a comparison may be used to validate the computing code being tested. Upon validating or invalidating the computing code, the system may use a feedback loop 512 (shown as status/feedback to localized bucket for code refining respective to resources in local agents) for further refining of the localized bucket and/or updating of the computing code, the determined dataset, and/or the computing component.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for securely testing computing code without downtime or over consumption of computing components, the system comprising:
a memory device with computer-readable program code stored thereon;
at least one processing device operatively coupled to the memory device and at least one communication device, wherein executing the computer-readable code is configured to cause the at least one processing device to:
identify computing code for testing;
apply the computing code to a localized bucket, wherein the localized bucket is configured to securely apply at least one determined dataset to the computing code;
determine, by a computing component allocator engine, at least one computing component to test the computing code;
apply the at least computing component to the localized bucket;
test, in the localized bucket, the computing code comprising the at least one determined dataset with the at least one computing component;
determine, based on the testing of the computing code, a simulated outcome of computing code; and
validate the computing code based on the simulated outcome.

2. The system of claim 1, wherein the validation of the computing code further comprises, and wherein executing the computer-readable code is configured to cause the at least one processing device to:
determine at least one production outcome associated with the at least one computing code or the at least one determined dataset, wherein the at least one production outcome is from a production environment outside of the localized bucket;
compare the at least one production outcome to the simulated outcome; and
determine, based on the comparison, an efficiency, a suitability, or an outcome of the computing code.

3. The system of claim 2, wherein executing the computer-readable code is configured to cause the at least one processing device to:
apply the efficiency, the suitability, or the outcome to the localized bucket via a feedback loop;
update the localized bucket based on the application of the efficiency, the suitability, or the outcome; and
determine, by the updated localized bucket, an updated at least one determined dataset, at least one updated computing code, or at least one updated computing component to improve at least one of the efficiency, the suitability, or the outcome of the computing code.

4. The system of claim 1, wherein the computing code is associated with at least one of a code update, a version upgrade, a new application, a new dataset, a security solution, or a streamed code.

5. The system of claim 1, wherein the at least one determined dataset is determined from a data model configured to select at least one pre-existing dataset from a plurality of pre-existing datasets or generate at least one synthetic datasets based on the at least one pre-existing dataset.

6. The system of claim 1, wherein the at least one determined dataset is a portion of a pre-existing production data or a portion of synthetic data based on pre-existing production data.

7. The system of claim 1, wherein the computing component allocator engine determines the at least one computing component based on the at least one computing component is idle.

8. The system of claim 1, wherein the computing component allocator engine comprises a grouping model that is configured to group and allocate available computing components based on at least one of historical production data or current production data.

9. The system of claim 1, wherein the computing code is saved on the at least one computing component for only a time required for testing.

10. The system of claim 1, wherein the localized bucket is isolated and secure from an operatively coupled network environment and a plurality of computing components in production within the operatively coupled network environment.

11. The system of claim 1, wherein executing the computer-readable code is configured to cause the at least one processing device to:
validate the at least one computing code based on an efficiency, a suitability, or an outcome of the computing code; and
apply, based on the validation, the at least one computing component comprising the at least one computing code to a production environment comprising non-idle computing components, wherein the application of the at least one computing component comprises zero downtime of the production environment.

12. A computer program product for securely testing computing code without downtime or over consumption of computing components, wherein the computer program product comprises at least one non-transitory computer-readable medium having computer-readable program code portions embodied therein, the computer-readable program code portions which when executed by a processing device are configured to cause the processor to:
identify computing code for testing;
apply the computing code to a localized bucket, wherein the localized bucket is configured to securely apply at least one determined dataset to the computing code;
determine, by a computing component allocator engine, at least one computing component to test the computing code;
apply the at least computing component to the localized bucket;
test, in the localized bucket, the computing code comprising the at least one determined dataset with the at least one computing component;
determine, based on the testing of the computing code, a simulated outcome of computing code; and
validate the computing code based on the simulated outcome.

13. The computer program product of claim 12, wherein the validation of the computing code further comprises, and wherein the computer-readable program code portions which when executed by the processing device are configured to cause the processor to:
determine at least one production outcome associated with the at least one computing code or the at least one determined dataset, wherein the at least one production outcome is from a production environment outside of the localized bucket;
compare the at least one production outcome to the simulated outcome; and
determine, based on the comparison, an efficiency, a suitability, or an outcome of the computing code.

14. The computer program product of claim 13, wherein the computer-readable program code portions which when executed by the processing device are configured to cause the processor to:
apply the efficiency, the suitability, or the outcome to the localized bucket via a feedback loop;
update the localized bucket based on the application of the efficiency, the suitability, or the outcome; and
determine, by the updated localized bucket, an updated at least one determined dataset, at least one updated computing code, or at least one updated computing component to improve at least one of the efficiency, the suitability, or the outcome of the computing code.

15. The computer program product of claim 12, wherein the at least one determined dataset is determined from a data model configured to select at least one pre-existing dataset from a plurality of pre-existing datasets or generate at least one synthetic datasets based on the at least one pre-existing dataset.

16. The computer program product of claim 12, wherein the computing component allocator engine determines the at least one computing component based on the at least one computing component is idle.

17. A computer implemented method for securely testing computing code without downtime or over consumption of computing components, the computer implemented method comprising:
identifying computing code for testing;
applying the computing code to a localized bucket, wherein the localized bucket is configured to securely apply at least one determined dataset to the computing code;
determining, by a computing component allocator engine, at least one computing component to test the computing code;
applying the at least computing component to the localized bucket;
testing, in the localized bucket, the computing code comprising the at least one determined dataset with the at least one computing component;
determining, based on the testing of the computing code, a simulated outcome of computing code; and
validating the computing code based on the simulated outcome.

18. The computer implemented method of claim 17, wherein the validation of the computing code further comprises:
determining at least one production outcome associated with the at least one computing code or the at least one determined dataset, wherein the at least one production outcome is from a production environment outside of the localized bucket;
comparing the at least one production outcome to the simulated outcome; and
determining, based on the comparison, an efficiency, a suitability, or an outcome of the computing code.

19. The computer implemented method of claim 18, further comprising:
applying the efficiency, the suitability, or the outcome to the localized bucket via a feedback loop;
updating the localized bucket based on the application of the efficiency, the suitability, or the outcome; and
determining, by the updated localized bucket, an updated at least one determined dataset, at least one updated computing code, or at least one updated computing component to improve at least one of the efficiency, the suitability, or the outcome of the computing code.

20. The computer implemented method of claim 17, wherein the at least one determined dataset is determined from a data model configured to select at least one pre-existing dataset from a plurality of pre-existing datasets or generate at least one synthetic datasets based on the at least one pre-existing dataset.
